(19) United States
(12) Patent Application Publication
(10) Pub. No.: US 2024/0315215 A1
(43) Pub. Date: Sep. 26, 2024

(54) SYSTEM AND PROCESS FOR LOW FLOW WATER MONITORING IN AGRICULTURE

(71) Applicant: BOARD OF TRUSTEES OF THE UNIVERSITY OF ARKANSAS, Litte Rock, AR (US)

(72) Inventors: Joseph Hiltz, Fayetteville, AR (US); Sara Orlowski, Springdale, AR (US); Lucas Harrington, Springdale, AR (US)

(73) Assignee: BOARD OF TRUSTEES OF THE UNIVERSITY OF ARKANSAS, Little Rock, AR (US)

(21) Appl. No.: 18/732,588

(22) Filed: Jun. 3, 2024

Related U.S. Application Data
(62) Division of application No. 17/313,971, filed on May 6, 2021.
(60) Provisional application No. 63/020,663, filed on May 6, 2020.

(51) Int. Cl. A01K 39/02; A01K 7/02; G01F 22/02

(52) U.S. Cl. CPC A01K 39/02; A01K 7/02; G01F 22/02; A01K 39/0213

(57) ABSTRACT

A system and process for low flow water monitoring in agriculture that measures water consumption at an individual bird/animal/plant level by weighing water in a controlled sealed environment. The system and process include a pressure regulation device fluidly connected to one or more reservoir tanks filled with water. The pressure regulation device is adjustable allowing for different output pressures suitable for many different agriculture applications.

### CROSS-REFERENCE TO RELATED APPLICATIONS

This application is a divisional application of U.S. patent application Ser. No. 17/313,971 filed on May 6, 2021, which claims the benefit of U.S. Provisional Patent Application Ser. No. 63/020,663 filed on May 6, 2020, and incorporates these applications by reference in their entirety into this document as if fully set out at this point.

### BACKGROUND OF THE INVENTION

### 1. Field of the Invention

This invention relates generally to a system and process for low flow water monitoring in agriculture, and more particularly to a system and process for low flow water monitoring in agriculture that measures water consumption at an individual bird/animal/plant level by weighing water in a controlled sealed environment.

### 2. Description of the Related Art

Water scarcity is a global problem and with anticipated population growth, freshwater resources will be limited for both human and agriculture applications. It is estimated that nearly 4 billion or two-thirds of the global population lives under conditions of severe water scarcity for at least one month a year and half a billion people live under severe water scarcity year-round. Furthermore, the United Nations Department of Economic and Social Affairs estimates the global population to reach 8.6 billion in 2030 and 9.8 billion in 2050. And to meet future demand and feed the projected population, we must increase our current food supply by 60 percent. Increasing our current food supply and an effort in trying to meet future demand will increase demand for freshwater. Some estimate that demand for freshwater (agriculture use) can increase by only 10 percent by 2050, which leaves over a 50 percent increase in water demand by the year 2020. To ensure a water sustainable and food secure future, we must become much more efficient in all phases of agriculture, including developing water efficient genetic agriculture lines (i.e., row crops, poultry, etc.) and developing more efficient water usage methodologies (i.e., utilization of new equipment/techniques).

Adopting the strategies above requires new technologies and selection tools. Agriculture industry professionals and geneticists have lacked the necessary technology and equipment essential to accurately measure water consumption/requirements in agriculture commodities. Water consumption in agriculture, more specifically poultry, has yet to be fully characterized at an individual bird level. Previous studies measuring water intake of broiler flocks utilized large scale flow meters on commercial styles houses. This technology proves inadequate for accurately measuring water consumption at an individual bird level required for genetic selection. Another study attempted to measure water consumption in a floor pen setting using 200 L graduated cylinders, while another study utilized soft drink bottle waterers and conventional mason jar waterers to measure water intake of selected and non-selected lines of broiler chickens. Both technologies employed in these prior studies are much different than a conventional nipple watering system and lack industry relevant application. The methods may be valid for large scale water intake characterization but the availability of flow meters capable of measuring flow of a single bird are almost nonexistent.

It is therefore desirable to provide a system and process for low flow water monitoring in agriculture.

It is further desirable to provide a system and process for low flow water monitoring in agriculture that measures water consumption at an individual bird/animal/plant level by weighing water in a controlled sealed environment.

It is yet further desirable to provide a system and process for low flow water monitoring for measuring and characterizing water consumption of poultry for genetic selection or for the selection of plants in quantities more than one.

Before proceeding to a detailed description of the invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

In general, in a first aspect, the invention relates to a system for low flow water monitoring in agriculture. The system includes a pressure regulation device in fluid communication with one or more water reservoir tanks. Each of the reservoir tanks has a water level sensor. The pressure regulation device also has one or more water nipple assemblies respectively in fluid communication with the reservoir tanks. The system also includes a computer processor in communication with the pressure regulation device. The computer processor is configured to provide real-time water level and consumption feedback from the reservoir tanks.

The pressure regulation device can be adjustable allowing for different air output pressures and water output volumes, such as using a regulator knob to selectively adjust the pressure within the reservoir tanks. Alternatively, the computer processor can include a controller to selectively adjust the air pressure and the water volume within the reservoir tanks. A pump can be utilized to selectively adjust the air pressure and the water volume within the reservoir tanks in response real-time water level and consumption feedback obtain from the water level sensor. The water level sensor of the reservoir tanks can be an internal water volume sensor, a water level indicator device, or a load cell. In addition, the low flow water monitoring system can be configured to rear broiler chickens in an individual floor pen or an individual bird cage.

In general, in a second aspect, the invention relates to a process for low flow water monitoring in agriculture using the low flow water system described herein. The process includes the steps of supplying water to an individual bird, animal or plant from the reservoir tanks filled with water; maintaining pressure of the supplied water using a pressure regulation device fluidly connected to the reservoir tanks; and measuring water consumption of the individual bird, animal or plant by weighing water in the reservoir tanks. The process can also provide real-time water level and consumption feedback using a computer processor in communication with the pressure regulation device.

In general, in a third aspect, the invention relates to a low flow water monitoring system for an individual floor pen or an individual bird cage. The system has a pressure regulation device in fluid communication with a plurality water reservoir tanks. Each of the reservoir tanks has a water volume sensor adapted to detect and provide water level readings within the reservoir tanks. The system also includes a memory component and a processing component housed within the pressure regulation device. The processing component is configured to receive the water level readings from the water volume sensor, and further configured to process the water level readings to generate water level and consumption data and information. The processing component also stores the water level and consumption data and information in the memory component. The system also includes a plurality of water nipple assemblies respectively in fluid communication with the reservoir tanks, and in fluid communication with the individual floor pen or the individual bird cage.

The processing component can be adapted to process the water level and consumption data and information to monitor water intake of one or more broiler chickens reared in the individual floor pen or the individual bird cage and can store the water intake in the memory component. The system can also include a wireless communication component adapted to communicate with a user over a wireless network. The water level and consumption data and information are collected locally via the processing component and provided to a computer over the wireless network via the communication component for remote viewing and analysis of the conditions by the user. The low flow water monitoring system can also include a plurality of the pressure regulation devices having a plurality of corresponding reservoir tanks with water volume sensors to form a network of the water volume sensors. The water volume sensors may be adapted to continuously monitor and provide feedback related to the water level and consumption data and information for the broiler chickens reared in the individual floor pen or the individual bird cage.

The foregoing has outlined in broad terms some of the more important features of the invention disclosed herein so that the detailed description that follows may be more clearly understood, and so that the contribution of the named inventors to the art may be better appreciated. The invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 is a perspective view of an example of a pressure regulation device fluidly connected to one or more reservoir tanks filled with water in accordance with an illustrative embodiment of the invention disclosed herein.

FIG. 2 is a front elevation view of the pressure regulation device and reservoir tanks shown in FIG. 1.

FIG. 3 is a perspective view of an example of a reservoir tank in accordance with

an illustrative embodiment of the invention disclosed herein.

FIG. 4 is a perspective view of another example of a reservoir tank in accordance with an illustrative embodiment of the invention disclosed herein.

FIG. 5 is a front elevation view of an example of a line of poultry pens having pressure regulation devices fluidly connected to reservoir tanks filled with water in accordance with an illustrative embodiment of the invention disclosed herein.

FIG. 6 is a detailed view of area 6 of FIG. 5.

FIG. 7 is a front perspective view of an example of a real-time pressure regulation

device with an individual bird cage in accordance with an illustrative embodiment of the invention disclosed herein.

FIG. 8 is a detailed view of area 8 of FIG. 7.

FIG. 9 is a rear perspective view of the real-time pressure regulation device and the individual bird cage shown in FIG. 7.

FIG. 10 is a front elevation view of the real-time pressure regulation device and the individual bird cage shown in FIG. 7.

FIG. 11 is a side elevation view of the real-time pressure regulation device and the individual bird cage shown in FIG. 7.

FIG. 12 is a flow chart diagram of low flow water monitoring system in accordance with an illustrative embodiment of the invention disclosed herein.

FIGS. 13A, 13B, 13C, and 13D are graphical representations water tank (WI) as compared to traits of economic importance (7 to 8 weeks) wherein FIG. 13A is wk 8 BW vs WI; FIG. 13B, 7 to 8 wk BWG vs WI; FIG. 13C, 7 to 8 wk FCR vs WI; FIG. 13D, 7 to 8 wk FI vs WI.

FIGS. 14A, 14B, 14C, and 14D are graphical representations water tank (WI) as compared to traits of economic importance (7 to 8 weeks) wherein FIG. 14A of 7 to 8 wk d35-d42 FI vs WI; FIG. 14B of 7 to 8 wk BWG vs WI; FIG. 14C, 7 to 8 wk FCR vs WI; FIG. 14D, 7 to 8 wk BW vs WI.

### DETAILED DESCRIPTION OF THE INVENTION

While this invention is susceptible of embodiment in many different forms, there is shown in the drawings, and will herein be described hereinafter in detail, some specific embodiments of the invention. It should be understood, however, that the present disclosure is to be considered an exemplification of the principles of the invention and is not intended to limit the invention to the specific embodiments so described.

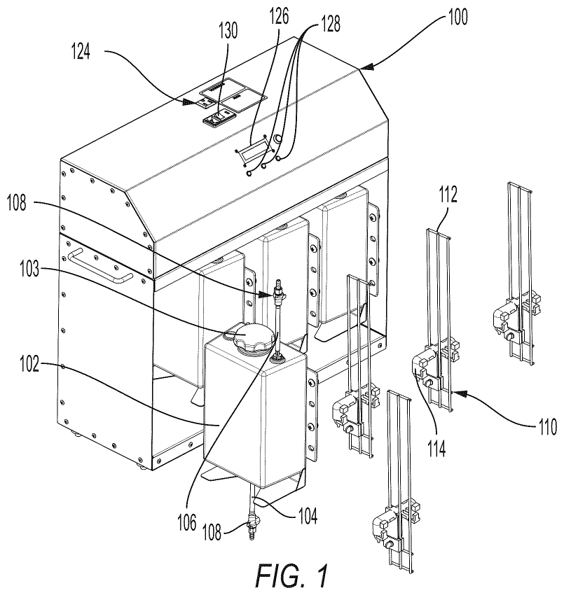

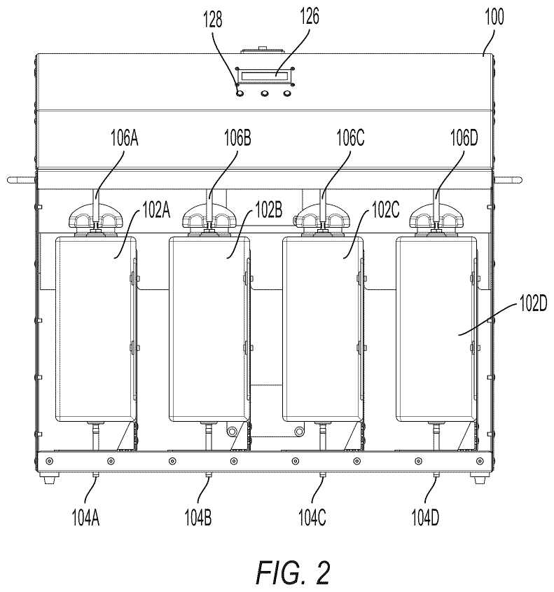

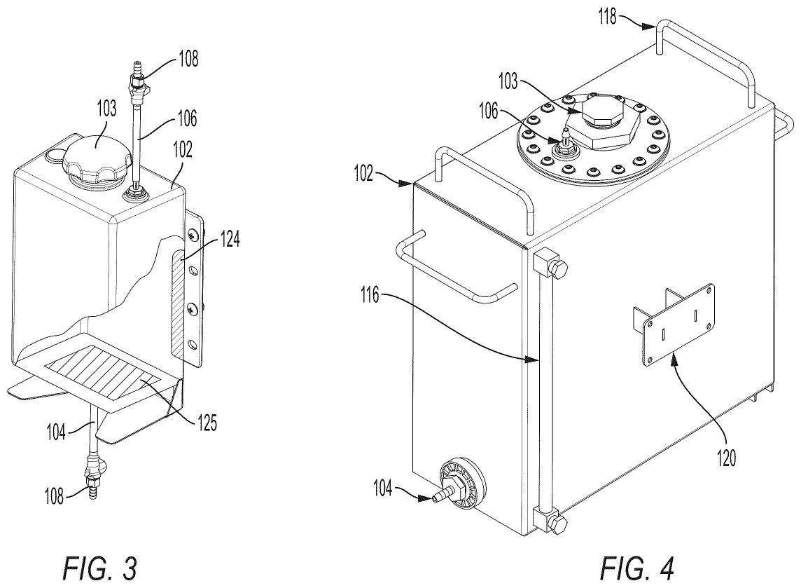

The invention generally relates to a system and process for low flow water monitoring in agriculture that measures water consumption at an individual bird/animal/plant level by weighing water in a controlled sealed environment. The inventive system and process includes a pressure regulation device 100 fluidly connected to one or more reservoir tanks 102 having a removable lid or plug 103 to add water. For example and as exemplified in FIGS. 1-6, the pressure regulation device 100 is connected to four individual reservoir tanks 102A, 102B, 102C, 102D allowing the system and method to measure the reservoir tanks 102 from one pressure regulation device 100.

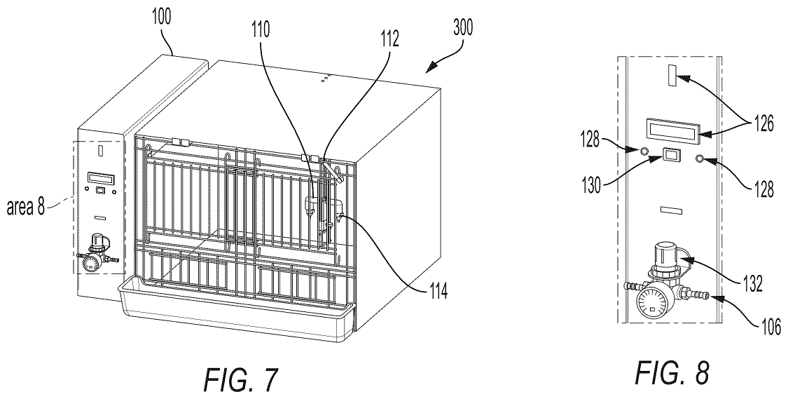

Each reservoir tank 102 is in fluid communication with the pressure regulation device 100 using water lines or ports 104 and air lines or ports 106, which can include no-leak quick connects 108. As exemplified in FIGS. 7 and 8 in connection with an individual cage watering system, a reservoir pressure adjustment apparatus 132 can be fluidly connected to the device 100 to allow selective adjustment of the pressure with the tanks 102. The pressure regulation device 100 pressurizes each reservoir tank 102A, 102B, 102C, 102D and provides the correct air pressure into the respective air lines 106A, 106B, 106C, 106D. The pressure regulation device 100 is adjustable allowing for different water output capacities from the respective water lines 104A, 104B, 104C, 104D suitable for many different agriculture applications. Each water line 104A, 104B, 104C, 104D is fluidly connected to a water nipple assembly 110 having a water nipple support 112 and a nipple drinker 114 mounted thereon. As exemplified in FIG. 4, each reservoir tank 102 can include a water level indicator device 116 fluidly mounted thereto. In addition, the reservoir tanks 102 can also include a water volume sensor 124. Further, each reservoir tank 102 may include a plurality of handles 118 and a mount 120 to connect to the pressure regulation device 100 with other reservoir tanks 102.

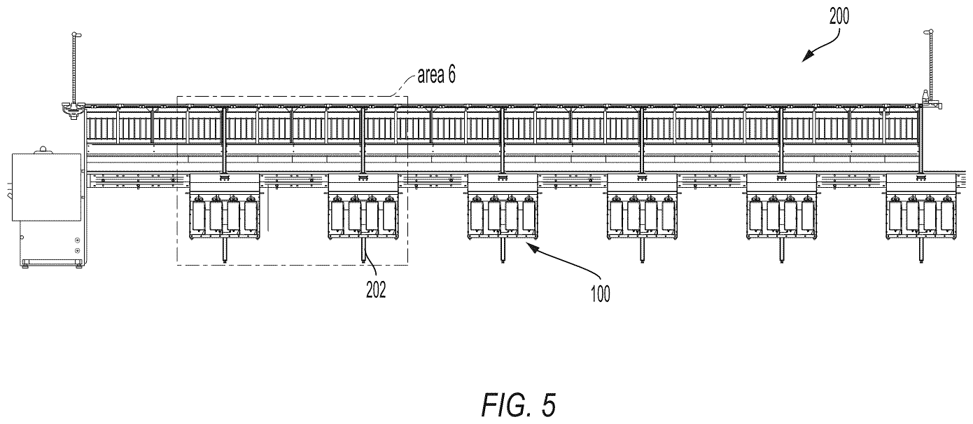

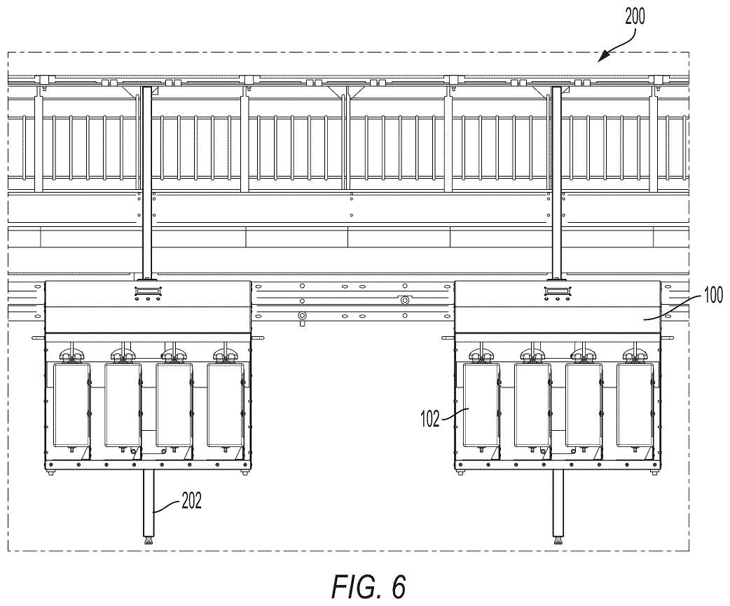

The pressure regulation device 100 can also include a suitable power source (not shown) and/or a power cord receptacle 124 to daisy chain together devices 100 to reduce the number of required power outlets or sources. As shown in FIGS. 5 and 6, a line of poultry pens 200 can have pressure regulation devices 100 fluidly connected to reservoir tanks 102 attached to a frame leg 202 or otherwise to the poultry pens 200.

The pressure regulation device 100 could also include a computer processor that provides real-time feedback from the reservoir tanks 102 and provides for real-time data pertaining to water consumption. The pressure regulation device 100 can include a controller 122 to selectively adjust the air pressure and the water volume within the reservoir tanks 102 using a pump 123 in response to real-time feedback data obtain from the internal water volume sensor 124. Alternative to determine water consumption data using volumetric data, the pressure regulation device 100 can include load cells or a water weight sensor 125, such as a highly sensitive voltage meter, to weigh each of the tanks 102. The voltage meter sensor can be utilized in line with the water lines 104, and the load cells include necessary electronics to measure the weight of the tanks 102.

The real-time data, including pressure and water usage, can be stored using the computer processor/controller 122 and displayed on an LCD display 126 mounted to the pressure regulation device 100. In addition, the pressure regulation device 100 can include a power switch 130 and a plurality of indicator lights 128 to visually display power status, system alarm status, power status, reservoir pressure, water volume, logging, water consumption metrics, and other operational status.

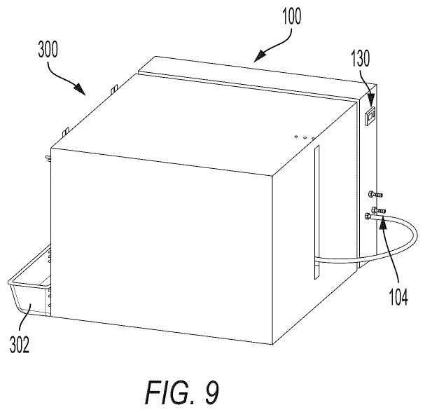

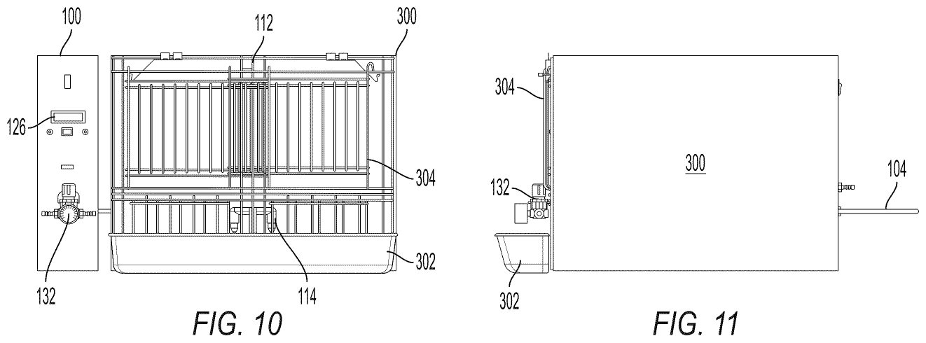

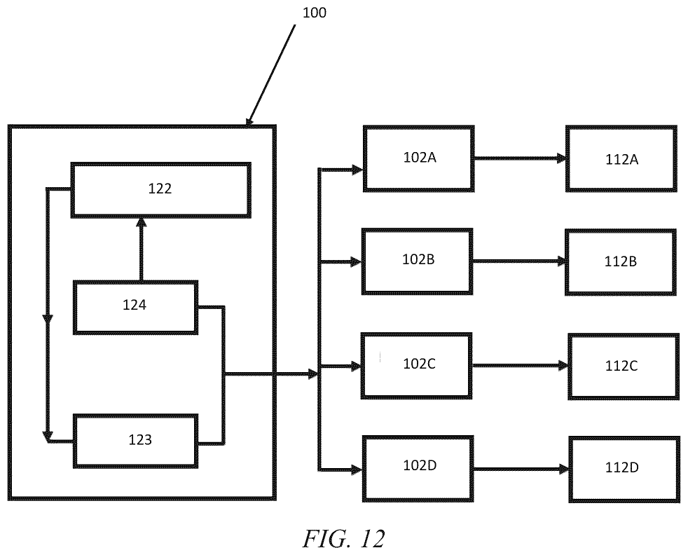

The low flow water monitoring system illustrated in FIGS. 1 through 6 is directed to an individual floor pen 200 with the pressure regulation device 100, whereas the low flow water monitoring system illustrated in FIGS. 7 through 11 is directed to an individual bird cage 300 with the pressure regulation device 100. The bird cage 300 includes a feeding tray 302 mounted to an exterior cage door 304, and the bird cage 300 includes the water nipple assembly 110 having the water nipple support 112 and the nipple drinker 114 mounted therein for access to the broiler chicken reared therein.

The system and process for low flow water monitoring can be used in all aspects of agriculture, including but not limited to, water monitoring systems and processes for horticulture, poultry, lab animals, other livestock species, testing equipment for poultry companies (e.g., feed additives/nutrition), water line manufacturers. The system and process for low flow water monitoring can also be used by human food and health and pharmaceutical companies.

### EXAMPLES

The system and process for low flow water monitoring disclosed herein is further illustrated by the following examples, which are provided for the purpose of demonstration rather than limitation. The foregoing examples demonstrate the system and process for low flow water monitoring that measures water consumption at an individual bird/animal/plant level by weighing water in a controlled sealed environment.

### Example 1—Pilot Trial

Plastic five-gallon buckets having watering nipples in the bottom of the bucket were initially used to measure water consumption. After the completion of the floor pen trial, the prototype was discontinued, and an individual gravity fed prototype was developed. Initial measurements were collected from two individual gravity fed setups. Although the gravity system had industry relevance, it did not provide the correct pressure, nor did it prove to be a sustain solution to measure water intake. The next generation was designed for a pen/group application. The pen application utilizes Lubing waterlines and nipples to deliver the water from a pressurized and sealed reservoir. The reservoir is pressurized and modulated by a pressure regulation box, where a microprocessor provides real time pressure readings. To measure water consumption, one disconnects and weighs the sealed reservoir. The version of the pen application could service four different pens/water line outputs. A pilot trial was conducted with six regulation devices servicing 24 floor pens of 650 broiler chickens.

After the successful development of the pen/group application, the individual bird low flow monitoring system was designed to be utilized in a feed conversion cage system where individual bird feed and water intake can be monitored. The individual system closely resembles the pen system but at a smaller scale. Each individual regulation devices delivers the correct water pressure to four individual birds. An initial pilot study utilizing the individual low flow monitoring system was conducted on 96 broilers.

Weekly water and feed intake by pen were collected as well as weekly individual body weights. Each water line and regulation device were meticulously monitored to ensure accurate water intake data. The individual low flow monitoring system yielded similar results. Individual water and feed intake in addition to bodyweight was recorded weekly.

Given the water consumption results of the system and process for low flow water monitoring at an individual bird/animal/plant level, new relationships between gain and water/feed can be formulated. Water to gain can be used as a selection parameter for geneticists, as water can become a fixed input cost. In Table 1 below, the relationship of water to gain is referred to as Water Conversion Ratio (“WCR”). The performance and efficacy the system and process for low flow water monitoring was validated as an effective and sustainable way to measure water consumption of an individual bird. The system and process for low flow water monitoring provides geneticists and researchers across all species an effective selection tool vital to the development of water efficient genetic lines and for the selection of plants in quantities more than one.

TABLE 1
Pilot Trial Results

| | | | | | | Feed Conversion | | |
|---|---|---|---|---|---|---|---|---|
| | | | | | | Ratio (kgs | | |
| | Bird | Bird | Bird | | | of feed | | |
| | Weight | Weight | Weight | | | consumption | | |
| Cage | (g) at | (g) at | Gain | H2O | Feed | to body | | Water:Feed |
| No. | Day 49 | Day 56 | (g) | intake | Intake | weight gained | WCR | Ratio |
| 266 | 3934 | 4676 | 742 | 2197.3 | 1796.7 | 2.421429 | 2.961321 | 1.222964 |
| 270 | 3848 | 4446 | 598 | 1874.4 | 1775.6 | 2.969231 | 3.134448 | 1.055643 |
| 299 | 3534 | 4200 | 666 | 2231.7 | 1415 | 2.124625 | 3.350901 | 1.577173 |
| 296 | 3621 | 4205 | 584 | 2045.4 | 1389 | 2.378425 | 3.502397 | 1.47257 |
| 226 | 3330 | 4041 | 711 | 2545.4 | 1535 | 2.158931 | 3.580028 | 1.658241 |
| 218 | 4032 | 4844 | 812 | 2941 | 1665 | 2.050493 | 3.621921 | 1.766366 |
| 311 | 3971 | 4785 | 814 | 2957 | 1352 | 1.660934 | 3.632678 | 2.18713 |
| 297 | 3812 | 4615 | 803 | 3030.1 | 1621 | 2.01868 | 3.773474 | 1.869278 |
| 229 | 3710 | 4298 | 588 | 2231.4 | 1839 | 3.127551 | 3.794898 | 1.213377 |
| 275 | 3943 | 4494 | 551 | 2158.5 | 1433 | 2.600726 | 3.917423 | 1.506281 |
| 259 | 3691 | 4489 | 798 | 3154.8 | 1714 | 2.14787 | 3.953383 | 1.840607 |
| 253 | 3776 | 4483 | 707 | 2795.4 | 1745.9 | 2.469448 | 3.95389 | 1.601123 |
| 242 | 3257 | 3613 | 356 | 1408.8 | 1036.7 | 2.912079 | 3.957303 | 1.358927 |
| 312 | 4253 | 5125 | 872 | 3524.1 | 1867 | 2.141055 | 4.041399 | 1.887574 |
| 233 | 4094 | 4650 | 556 | 2255.3 | 1402 | 2.521583 | 4.056295 | 1.608631 |
| 309 | 3499 | 4340 | 841 | 3422.6 | 1975 | 2.348395 | 4.069679 | 1.732962 |
| 284 | 4027 | 4915 | 888 | 3638.3 | 1770.6 | 1.993919 | 4.097185 | 2.05484 |
| 237 | 4100 | 4909 | 809 | 3330.6 | 2004 | 2.477132 | 4.116934 | 1.661976 |
| 235 | 4181 | 5141 | 960 | 3977.6 | 1949 | 2.030208 | 4.143333 | 2.040841 |
| 265 | 3755 | 4517 | 762 | 3172.6 | 1691.6 | 2.219948 | 4.163517 | 1.875502 |
| 267 | 3120 | 3545 | 425 | 1776.4 | 863.4 | 2.031529 | 4.179765 | 2.057447 |
| 280 | 3944 | 4798 | 854 | 3576.2 | 1841.1 | 2.155855 | 4.187588 | 1.942426 |
| 289 | 4068 | 4625 | 557 | 2336.1 | 1455 | 2.612208 | 4.194075 | 1.605567 |
| 274 | 4310 | 4856 | 546 | 2302.5 | 1232.5 | 2.257326 | 4.217033 | 1.868154 |
| 241 | 3791 | 4658 | 867 | 3667.6 | 1548.2 | 1.785698 | 4.230219 | 2.368945 |
| 308 | 3945 | 4500 | 555 | 2356.6 | 1437 | 2.589189 | 4.246126 | 1.639944 |
| 291 | 3938 | 4603 | 665 | 2837.6 | 1737 | 2.61203 | 4.267068 | 1.633621 |
| 227 | 4210 | 4855 | 645 | 2805 | 1580 | 2.449612 | 4.348837 | 1.775316 |
| 281 | 3916 | 4529 | 613 | 2687 | 1755.5 | 2.863785 | 4.383361 | 1.530618 |
| 277 | 3590 | 4255 | 665 | 2917.4 | 1618 | 2.433083 | 4.387068 | 1.80309 |
| 240 | 3774 | 4331 | 557 | 2448.8 | 1424 | 2.556553 | 4.396409 | 1.719663 |
| 256 | 3684 | 4219 | 535 | 2352.5 | 1430 | 2.672897 | 4.397196 | 1.645105 |
| 223 | 4081 | 4956 | 875 | 3950.6 | 2070 | 2.365714 | 4.514971 | 1.908502 |
| 293 | 3917 | 4705 | 788 | 3599 | 1763 | 2.23731 | 4.567259 | 2.041407 |
| 264 | 3415 | 4349 | 934 | 4294.4 | 1832.3 | 1.961777 | 4.597859 | 2.343721 |
| 225 | 3931 | 4491 | 560 | 2620.5 | 1402 | 2.503571 | 4.679464 | 1.869116 |
| 276 | 4102 | 4638 | 536 | 2529.6 | 1614.3 | 3.011754 | 4.719403 | 1.566995 |
| 221 | 4005 | 4574 | 569 | 2689.2 | 1550 | 2.724077 | 4.726186 | 1.734968 |
| 292 | 3999 | 4960 | 961 | 4613 | 2231 | 2.32154 | 4.800208 | 2.067683 |
| 257 | 3830 | 4689 | 859 | 4133 | 1980.2 | 2.305239 | 4.811409 | 2.087163 |
| 260 | 3586 | 4092 | 506 | 2441 | 1368.4 | 2.704348 | 4.824111 | 1.783835 |
| 247 | 4270 | 5023 | 753 | 3666.9 | 1912.8 | 2.540239 | 4.869721 | 1.917033 |
| 272 | 4051 | 4662 | 611 | 3043.3 | 1711.4 | 2.800982 | 4.980851 | 1.778252 |
| 228 | 3568 | 4026 | 458 | 2296.5 | 1258 | 2.746725 | 5.014192 | 1.825517 |
| 300 | 4050 | 4570 | 520 | 2612.7 | 1383 | 2.659615 | 5.024423 | 1.889154 |
| 294 | 3492 | 3830 | 338 | 1709.7 | 1088 | 3.218935 | 5.058284 | 1.571415 |
| 307 | 3635 | 4019 | 384 | 1956.3 | 1253 | 3.263021 | 5.094531 | 1.561293 |
| 263 | 4387 | 5249 | 862 | 4436.4 | 1870.9 | 2.170418 | 5.146636 | 2.371265 |
| 310 | 2986 | 3530 | 544 | 2810 | 1761 | 3.237132 | 5.165441 | 1.595684 |
| 304 | 3461 | 3900 | 439 | 2274.6 | 1398 | 3.18451 | 5.181321 | 1.627039 |
| 261 | 3974 | 4546 | 572 | 3004.7 | 1438.6 | 2.515035 | 5.252972 | 2.088628 |
| 298 | 3937 | 4575 | 638 | 3397.2 | 1682 | 2.636364 | 5.324765 | 2.019738 |
| 249 | 4405 | 5093 | 688 | 3678.8 | 1752 | 2.546512 | 5.347093 | 2.099772 |
| 250 | 3730 | 4205 | 475 | 2563.9 | 1416.1 | 2.981263 | 5.397684 | 1.810536 |
| 269 | 4402 | 4889 | 487 | 2642.9 | 1732.6 | 3.5577 | 5.426899 | 1.525395 |
| 243 | 3239 | 3725 | 486 | 2662.8 | 1382.9 | 2.845473 | 5.479012 | 1.925519 |
| 234 | 4016 | 4582 | 566 | 3112 | 1791 | 3.164311 | 5.498233 | 1.737577 |
| 279 | 3843 | 4624 | 781 | 4331.3 | 2053.6 | 2.629449 | 5.545839 | 2.109125 |
| 220 | 4111 | 4507 | 396 | 2288.9 | 1332 | 3.363636 | 5.780051 | 1.718393 |
| 268 | 3535 | 4033 | 498 | 2914 | 1461.5 | 2.934739 | 5.851406 | 1.993842 |
| 306 | 3802 | 4112 | 310 | 1818.8 | 1120 | 3.612903 | 5.867097 | 1.623929 |
| 236 | 4081 | 4402 | 321 | 1903.3 | 1437 | 4.476636 | 5.929283 | 1.324495 |
| 278 | 3230 | 3598 | 368 | 2196.7 | 1150.2 | 3.125543 | 5.969293 | 1.909842 |
| 239 | 4022 | 4640 | 618 | 3758.3 | 1972 | 3.190939 | 6.081392 | 1.905832 |
| 255 | 3833 | 4251 | 418 | 2583.6 | 1637.2 | 3.916746 | 6.180861 | 1.57806 |
| 248 | 4131 | 4399 | 268 | 1692.9 | 1251.8 | 4.670896 | 6.316791 | 1.352373 |
| 230 | 3980 | 4371 | 391 | 2576.6 | 1308 | 3.345269 | 6.58977 | 1.969878 |
| 258 | 3672 | 4041 | 369 | 2451.2 | 1627.6 | 4.41084 | 6.642818 | 1.506021 |
| 219 | 3837 | 4196 | 359 | 2398.6 | 1546 | 4.306407 | 6.681337 | 1.551488 |
| 282 | 3999 | 4249 | 250 | 1714.4 | 1153 | 4.612 | 6.8576 | 1.486904 |
| 252 | 3811 | 4224 | 413 | 2893 | 1439.4 | 3.48523 | 7.004843 | 2.009865 |
| 217 | 3921 | 4247 | 326 | 2285.5 | 1091 | 3.346626 | 7.010736 | 2.094867 |
| 285 | 4395 | 4909 | 514 | 3605.8 | 1882 | 3.661479 | 7.015175 | 1.91594 |
| 283 | 3963 | 4466 | 503 | 3722.1 | 1660.2 | 3.300596 | 7.399801 | 2.241959 |

### Example 2—Floor Pen Water System

For this experiment, the low flow water monitoring system was designed for measuring water consumption for birds reared in an individual floor pen (e.g., FIGS. 1-6) or for a single bird cage application (e.g., FIGS. 7-10). Briefly, the floor pen application utilized Lubing waterlines and nipples to deliver the water from a pen dedicated, sealed, pressurized water reservoir. A controller housed in the regulation device was used to sustain a constant pressure of about six (6) psi on the water to the nipple drinker water line. This pressure was determined based on achieving a nipple flow rate of forty-five (45) ml/min and assuring no system leakage. This solved the need for reservoir tank suspension as would be necessary for gravity fed systems. An internal microprocessor maintained real-time pressure regulation within the reservoir tanks. To measure water consumption, each water reservoir was filled, weighed, and connected to the pressure regulation device. After the sampling period, the reservoir tanks were disconnected from the drip free connector and weighed. Water intake (WI) was calculated as the weight change (1 g water =1 mL water) from start to finish of the trial period. This exemplary application of the floor pen simultaneously supported water distribution to four (4) different poultry floor pens. Each floor pen had the water reservoir tank capacity of 7.6 L.

To test the floor pen embodiment of the lower water monitoring system, a pilot trial was conducted with six (6) regulation devices servicing twenty (24) floor pens (1.32 m×3.66 m). Each floor pen was equipped with two (2) commercial hanging feeders and a nipple drinker line (two (2) nipple drinkers/pen). In addition to the conventional nipple drinker line, each floor pen had one supplemental one (1) gallon waterer during the first week of the trial period. The supplemental waterer was included to guarantee adequate welfare by ensuring birds had access to water given the unproven performance of the novel water monitoring system.

A total of 650 fully pedigreed broiler chicks were generated from a two (2) week egg collection from the 2015 Modern Randombred line (Orlowski et al., 2020) housed at the University of Arkansas poultry research farm. Chicks were hatched, wing banded, vaccinated for Marek's disease and randomly assigned to floor pens based on sire family. Each sire family consisted of all offspring generated from three (3) dams mated to a single sire. Broilers were fed a commercial starter diet (Day 0 to 28) formulated to meet or exceed NRC requirements. Weekly WI, feed intake (FI) and individual body weight (BW) was recorded for each floor pen. Each water line and regulation device were monitored for leaks to ensure accurate WI data.

During the experimental of Example 1, the low flow water monitoring system was able to characterize WI in a floor pen setting. Average WI+SD per bird was 344+46 week 0 to 1, 797+57 week 1 to 2, 1245+66 week 2 to 3 and 1789+103 for week 3 to 4. These WI measures were some the first recorded values for modern-day broiler water consumption. In general, these WI values were consistently higher than found by Pesti et al., 1985. This is likely associated with BW since the 1985 broiler was substantially lighter, having half the weight of the modern broiler tested in this study. Pesti et al., (1985) estimated a daily water consumption standard of 5.284 g×age (day). For this study, a similar predictor would be 10.26 g×age (day). Considering WI in relation to gain allowed for the calculation of average WCR+SD; 3.40+0.58 week 0 to 1, 2.88+0.26 week 1 to 2, 3.02+0.28 week 2 to 3 and 3.23+0.21 for week 3 to 4. The higher WCR for week 0 to 1 is due to the inclusion of the supplemental waterers. The general increase in WCR from week 1 to 4 reflects the greater maintenance cost as the bird ages.

Water measurement using the inventive system allowed for the accurate and repeatable measure of WI in a floor pen and individual cage system. Since chicks were placed by sire family there were different stocking densities across floor pens. However, crowding in this trial was not an issue regardless of the density as the lowest floor space per chick was 0.13 m² (1.4 ft²) to 4 weeks. The ability of the water monitoring system to distinguish between high density verses low density floor pens was the first comparison. All correlations between WI measures by week were high and significant (Table 1).

TABLE 1
Pearson correlations¹ of weekly water intake (WI) from hatch (0) to
4 weeks by sire family pen² (above diagonal) and by average per
chick water consumption within sire family pen³ (below diagonal).

| Water consumption | | | | |
|---|---|---|---|---|
| period (week) | 0 to 1 | 1 to 2 | 2 to 3 | 3 to 4 |
| 0 to 1 | 1.000 | 0.938*** | 0.895*** | 0.845*** |
| 1 to 2 | 0.651*** | 1.000 | 0.976*** | 0.934*** |
| 2 to 3 | 0.427* | 0.635*** | 1.000 | 0.990*** |
| 3 to 4 | 0.093 | 0.435* | 0.861*** | 1.000 |

¹Significant correlation indicated by *p < .05; **p < .01; ***p < .001.
²Correlations were based on total g WI/week for all birds in floor pen.
³Correlations were based on weighted WI/bird/week by floor pen.

When expressing WI on a per bird, per pen or per week basis, significant correlations were found (Table 1). Significant correlations were strongest between single week intervals (week 0 to 1 and 1 to 2, 1 to 2 and 2 to 3 and week 2 to 3 and 3 to 4). When extended to a two (2) week interval (week 0 to 1 and 2 to 3 and 1 to 2 and 3 to 4) correlations were still significant but lower. No correlation was found for individual per bird WI between week 0 to 1 and 3 to 4. Supplemental waterers were used for the first week of production and as a result water usage lost to evaporation or spillage inflated week 0 to 1 WI. Regardless, these results support the premise that high-water consumption birds maintain high consumption over time while low consumption birds continue to be low.

### Example 3—Individual Cage Water System

For this experimental, the individual bird low flow monitoring system was designed to be utilized in a feed conversion cage system where an individual bird's FI and WI could be monitored. The individual system closely resembled the floor pen system of Example 2 but on a smaller scale with water reservoir capacities of four (4) L. Each regulation device housed four cage dedicated reservoir tanks constantly delivering a desired water pressure of 0.5 PSI to each individual nipple waterer cage setup.

An initial pilot study utilizing the individual low flow monitoring system was conducted on 74 male broilers from the 2015 Modern Randombred line (Orlowski et al., 2020). The male broilers were taken directly from Example 2 and represent the top six (6) and bottom six (6) sire families based on water conversion measured in Example 2 above from 1 to 4 weeks of age. Water conversion ratio (WCR) was calculated as WI (g)/BWG (g) over the same time period. The selected broilers were housed in individual cages (0.46 m×0.31 m×0.41 m) fitted with feed conversion bunkers and a nipple waterer leading to the pressure monitoring device. The male broilers were individually caged at 5 weeks and allowed 2 weeks to acclimate. Weekly WI, FI and BW was monitored during the acclimation period and used to identify birds that did not transition well to the cage system. The data presented represented individual bird WI, FI and BW data collected from 7 to 8 wk. A commercial finisher feed and water were provided ad libitum.

To demonstrate the efficacy of the individual bird low flow monitoring system, Pearson correlations were calculated by week for WI per floor pen and average WI per bird by sire family. For the individual cage water consumption analysis, data was presented as a scatter plot of individual bird WI verses other traits of economic importance. Best fit regression lines are provided. All statistics were analyzed utilizing JMP Pro 15.4.

Chicks were housed in floor pens by sire family to use results from the floor pen low flow water system of Example 2 to preselect birds from high and low water conversion families. At five (5) weeks, a total of ninety-six (96) male birds from the high and low groupings were moved to individual cages fitted with nipple waterers driven by the low flow water monitoring system. Birds were allowed two (2) weeks to acclimate. After removal of birds that did not have complete data or failed to acclimate to the individual cage environment, seven-four (74) males remained.

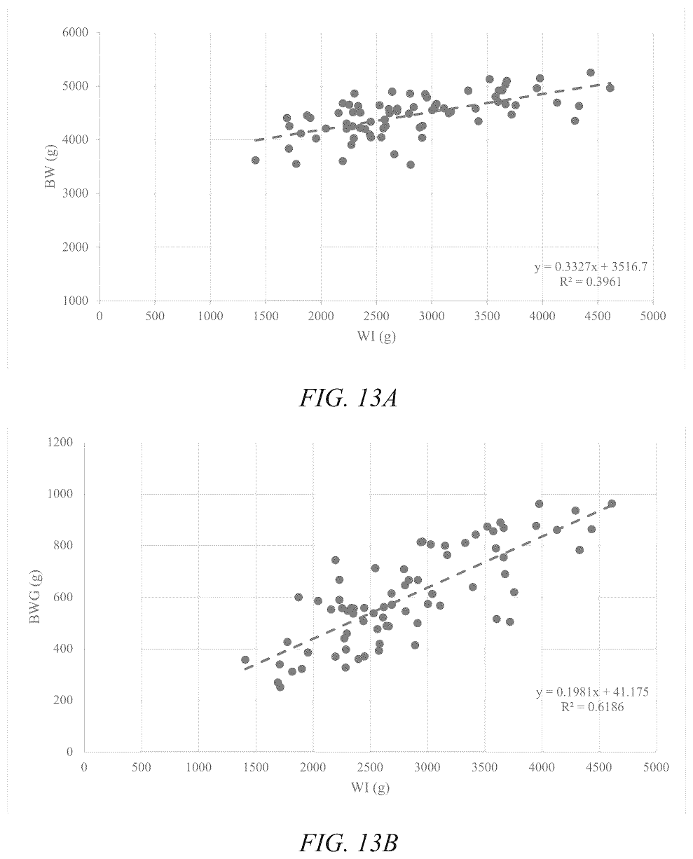

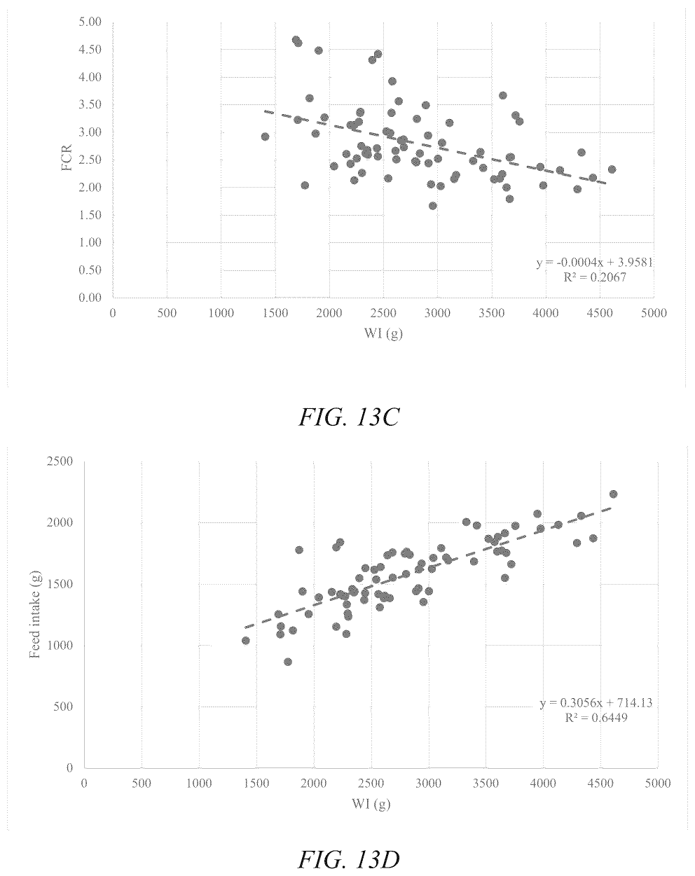

WI from weeks seven (7) to eight (8) was compared with traits of economic importance in FIG. 13. As illustrated, there was a slight positive relationship between WI and 8 wk BW (FIG. 13A). The heaviest birds consumed the most water as expected but there was a large proportion of the population that had relatively high eight (8) week BW and average WI. FIG. 13B displays a positive linear relationship between WI and seven (7) to eight (8) weeks BWG. Although there appeared to be a positive relationship, many of the birds showed variation in how they utilize/convert water into live weight. A slight negative relationship was observed for WI and feed conversion ratio (FCR) (FIG. 13C). This experimental plot exhibited the most variation within the flock and showed that feed utilization is not an obvious function of WI. The most conclusive linear relationship was between FI and WI (FIG. 13D). Although the literature has often deemed water-to-feed (W:F) ratios to be 2.0 (Gardiner and Hunt, 1984; Marks, 1980, 1981, 1985), there is more variation than expected. Variation of water conversion ratio among the selected males was much larger. The most efficient individual had a WCR of 2.96, conversely the most inefficient individual yielded a WCR of 7.40. The average WCR of the population was 4.89+1.02 for seven (7) to eight (8) weeks of age.

Given the results of this preliminary experimental trial using data gather from the lower water regulation device, new relationships between production traits as influenced by WI were explored. The inventive system can be utilized with a real time WCR by committing a load cell to each reservoir. WCR could be added as a selection parameter for geneticists, as undeniably water will become a variable input cost. The performance and efficacy of the low flow water monitoring system are shown to be an effective and sustainable way to measure individual bird water consumption.

### Example 4—Divergent Selection for WCR

Like Example 3 above, the male broilers were taken directly from Example 2 and

represent the top six (6) and bottom six (6) sire families based on water conversion measured in Example 2 above from 1 to 4 weeks of age. Water conversion ratio (WCR) was calculated as WI (g)/BWG (g) over the same time period. The data presented represented individual bird WI. FI and BW data collected from 7 to 8 wk.

TABLE 2
High water efficient genetic line - pen system.

| Week | 1 | 2 | 3 | 4 | 1-4 |
|---|---|---|---|---|---|
| FI | 140.15 | 512.02 | 554.14 | 880.08 | 2086.83 |
| FCR | 1.44 | 1.96 | 1.54 | 1.52 | 1.63 |
| WI | 272.51 | 769.06 | 1137.42 | 1998.43 | 4187.31 |
| WCR | 2.82 | 2.73 | 3.18 | 3.46 | 3.28 |
| W:F | 2.07 | 2.05 | 2.07 | 2.33 | 2.02 |
| BW | 153.42 | 436.31 | 797.99 | 1387.90 | |

TABLE 3
Low water efficient genetic line - pen system.

| Week | 1 | 2 | 3 | 4 | 1-4 |
|---|---|---|---|---|---|
| FI | 149.90 | 537.77 | 564.80 | 891.01 | 2123.16 |
| FCR | 1.63 | 2.21 | 1.85 | 1.57 | 1.72 |
| WI | 263.66 | 739.20 | 1191.59 | 2036.18 | 4296.99 |
| WCR | 2.83 | 2.86 | 3.82 | 3.55 | 3.46 |
| W:F | 1.91 | 2.11 | 2.11 | 2.04 | 2.04 |
| BW | 137.93 | 396.00 | 752.01 | 1329.25 | |

TABLE 4
High water efficient genetic line - Top 6 Sire families - pen system.

| Week | 1 | 2 | 3 | 4 | 1-4 |
|---|---|---|---|---|---|
| FI | 142.56 | 517.48 | 558.70 | 787.46 | 2006.19 |
| FCR | 1.45 | 1.90 | 1.53 | 1.32 | 1.52 |
| WI | 270.05 | 762.73 | 1148.78 | 1875.35 | 4056.92 |
| WCR | 2.76 | 2.59 | 3.14 | 3.13 | 3.07 |
| W:F | 1.98 | 2.06 | 2.06 | 2.44 | 2.03 |
| BW | 154.48 | 449.17 | 816.64 | 1416.62 | |

TABLE 5
Low water efficient genetic line - Top 6 Sire families - pen system.

| Week | 1 | 2 | 3 | 4 | 1-4 |
|---|---|---|---|---|---|
| FI | 166.31 | 518.43 | 569.25 | 873.08 | 2127.07 |
| FCR | 1.83 | 2.15 | 1.63 | 1.55 | 1.73 |
| WI | 265.69 | 785.67 | 1238.51 | 2162.09 | 4451.96 |
| WCR | 2.86 | 2.96 | 3.54 | 3.81 | 3.60 |
| W:F | 1.71 | 2.17 | 2.17 | 2.54 | 2.11 |
| BW | 144.48 | 409.54 | 762.39 | 1326.88 | |

TABLE 6
Individual cage Line comparison (single bird
application) High water efficency line

| Week | 5 | 6 | 5-6 |
|---|---|---|---|
| FI | 1159.44 | 1371.23 | 2530.67 |
| FCR | 1.80 | 1.86 | 1.82 |
| WI | 2251.41 | 2611.63 | 4863.04 |
| WCR | 3.59 | 3.53 | 3.50 |
| W:F | 1.95 | 1.91 | 1.92 |
| BWG | 654.29 | 747.50 | 1401.78 |
| BW | 2153.62 | 2904.40 | |

TABLE 7
Individual cage Line comparison (single bird
application) Low water efficency line.

| Week | 5 | 6 | 5-6 |
|---|---|---|---|
| FI | 1190.43 | 1470.61 | 2655.01 |
| FCR | 1.80 | 1.75 | 1.76 |
| WI | 2546.93 | 3186.10 | 5717.38 |
| WCR | 3.86 | 3.75 | 3.78 |
| W:F | 2.14 | 2.16 | 2.15 |
| BWG | 663.32 | 847.76 | 1511.08 |
| BW | 2109.13 | 2956.90 | |

TABLE 8
Individual cage Line comparison (single bird application)
High water efficency line Top 18 male chicks.

| Week | 5 | 6 | 5-6 |
|---|---|---|---|
| FI | 1157.17 | 1385.14 | 2534.98 |
| FCR | 1.75 | 1.82 | 1.77 |
| WI | 2080.46 | 2552.00 | 4638.68 |
| WCR | 3.15 | 3.39 | 3.25 |
| W:F | 1.80 | 1.85 | 1.83 |
| BWG | 668.81 | 766.26 | 1435.07 |
| BW | 2140.29 | 2906.56 | |

TABLE 9
Individual cage Line comparison (single bird application)
Low water efficency line Top 18 male chicks.

| Week | 5 | 6 | 5-6 |
|---|---|---|---|
| FI | 1185.48 | 1466.46 | 2659.38 |
| FCR | 1.85 | 1.73 | 1.78 |
| WI | 2732.30 | 3441.62 | 6192.46 |
| WCR | 4.26 | 4.01 | 4.11 |
| W:F | 2.30 | 2.33 | 2.32 |
| BWG | 640.65 | 856.30 | 1496.95 |
| BW | 2115.87 | 2972.17 | |

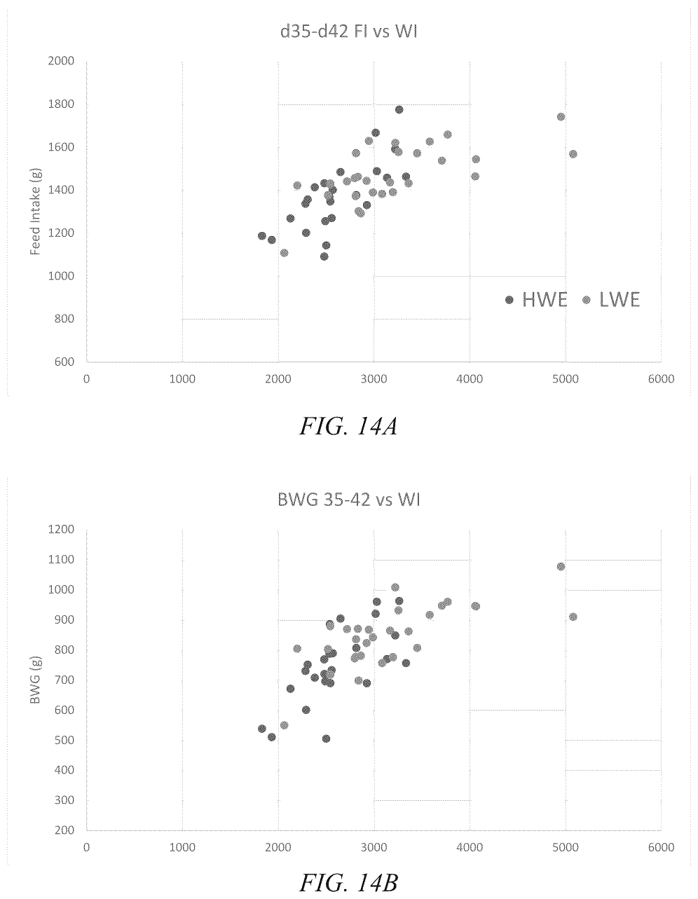

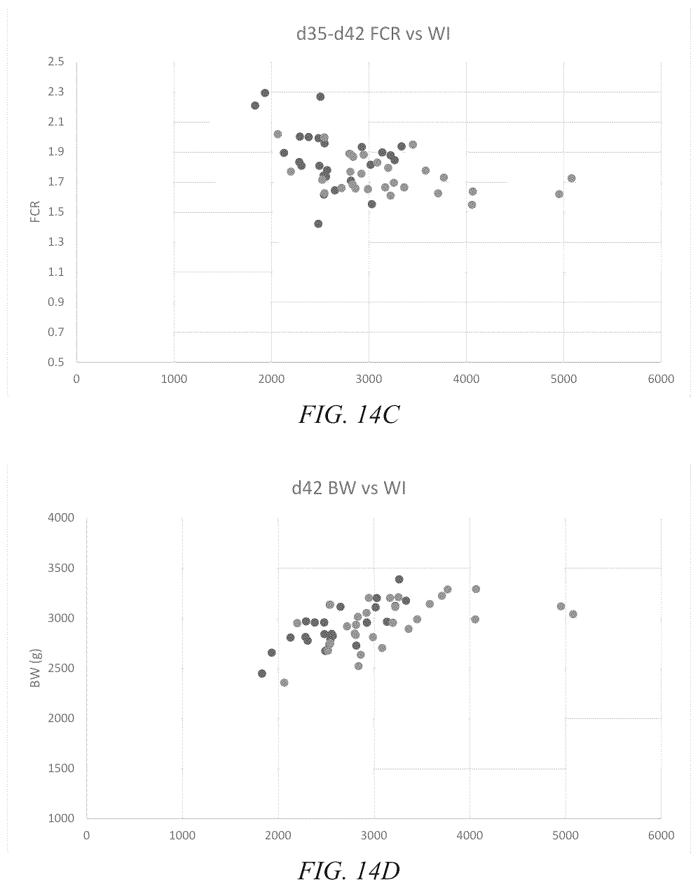

WI from weeks seven (7) to eight (8) was compared with traits of economic importance in FIG. 14. As illustrated and similar to Examples 2-3, there was a slight positive relationship between WI and 8 wk feed intake, BWG, FCR, and BW (FIGS. 14A-14D).

As noted above, The low flow monitoring system can include a processing component, a memory component, a display component, a control component, a communication component, a power component, and an optional a mode sensing component.

The processing component includes a microprocessor, a single-core processor, a multi-core processor, a microcontroller, a logic device (e.g., programmable logic device configured to perform processing functions), a digital signal processing (DSP) device, or some other type of generally known processor, including image processors and/or video processors. Processing component is adapted to interface and communicate with the components of the thermal scanning system to perform method and processing steps as described herein. Processing component may include one or more modules for operating in one or more modes of operation, and the modules may be adapted to define preset processing and/or display functions that may be embedded in processing component or stored on memory component for access and execution by processing component. For example, processing component may be adapted to operate, control and store water usage and consumption information in memory component. In other various embodiments, processing component may be adapted to perform various types of water consumption processing algorithms and/or various modes of operation, as described herein.

It should be appreciated that each module may be integrated in software and/or hardware as part of processing component, or code (e.g., software or configuration data) for each mode of operation associated with each module, which may be stored in memory component. Modules may be stored by a separate computer-readable medium (e.g., a memory, such as a hard drive, a compact disk, a digital video disk, or a flash memory) to be executed by a computer (e.g., logic or processor-based system) to perform various methods disclosed herein.

In one example, the computer-readable medium may be portable and/or located separate from the low flow monitoring system, with stored modules provided to the low flow monitoring system by coupling the computer-readable medium to the pressure regulation device(s) and/or by the low flow monitoring system downloading (e.g., via a wired or wireless link) the modules from the computer-readable medium (e.g., containing the non-transitory information). In various embodiments, as described herein, modules provide for improved low flow monitoring processing techniques for real time applications.

Memory component includes one or more memory devices to store data and information, including water usage and consumption data and information. The one or more memory devices may include various types of memory for data storage including volatile and non-volatile memory devices, such as RAM (Random Access Memory), ROM (Read-Only Memory), EEPROM (Electrically-Erasable Read-Only Memory), flash memory, etc. In one embodiment, processing component is adapted to execute software stored on the memory component to perform various methods, processes, and modes of operations in manner as described herein.

Regulation component includes one or more weight, volumetric, and/or pressure sensors for capturing data related to water usage and consumption. The volumetric or weight-based sensors may be adapted to determine water level within each of the reservoir tanks using volume data. Pressure sensors log pressure data from within the reservoir tanks. Processing component may be adapted to receive water consumption data from regulation component, process water level signals (e.g., to provide processed water consumption data), store volume and pressure signals or data in memory component, and/or retrieve stored water usage and consumption data from memory component. Processing component may be adapted to process volume and pressure signals or data stored in memory component to provide water usage and consumption data to display component for viewing by a user.

Display component includes, in one embodiment, an image display device (e.g., a liquid crystal display (LCD)) or various other types of generally known video displays or monitors. Processing component may be adapted to display water level and consumption data and information on display component. Processing component may be adapted to retrieve water level and consumption data and information from memory component and display any retrieved water level and consumption data and information on display component. Display component may include display electronics, which may be utilized by processing component to display water level and consumption data and information. Display component may receive image data and information directly from regulation component via processing component, or the water level and consumption data and information may be transferred from memory component via processing component.

Control component includes a user input and/or interface device having one or more user actuated components. For example, actuated components may include one or more push buttons, slide bars, rotatable knobs, and/or a keyboard, that are adapted to generate one or more user actuated input control signals. Control component may be adapted to be integrated as part of display component to function as both a user input device and a display device, such as, for example, a touch screen device adapted to receive input signals from a user touching different parts of the display screen. Processing component may be adapted to sense control input signals from control component and respond to any sensed control input signals received therefrom.

Control component may include a control panel unit (e.g., a wired or wireless handheld control unit) having one or more user-activated mechanisms (e.g., buttons, knobs, sliders, etc.) adapted to interface with a user and receive user input control signals. In various embodiments, the one or more user-activated mechanisms of the control panel unit may be utilized to select between the various modes of operation, as described herein in reference to the stored modules. In other embodiments, it should be appreciated that the control panel unit may be adapted to include one or more other user-activated mechanisms to provide various other control functions of the lower water monitoring system.

In another embodiment, control component may include a graphical user interface (GUI), which may be integrated as part of display component (e.g., a user actuated touch screen), having one or more images of the user-activated mechanisms (e.g., buttons, knobs, sliders, etc.), which are adapted to interface with a user and receive user input control signals via the display component.

Communication component may include, in one embodiment, a network interface component (NIC) adapted for wired and/or wireless communication with a network including other devices in the network. In various embodiments, communication component may include a wireless communication component, such as a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components, such as wireless transceivers, adapted for communication with a wired and/or wireless network. As such, communication component may include an antenna coupled thereto for wireless communication purposes. In other embodiments, the communication component may be adapted to interface with a wired network via a wired communication component, such as a DSL (e.g., Digital Subscriber Line) modem, a PSTN (Public Switched Telephone Network) modem, an Ethernet device, and/or various other types of wired and/or wireless network communication devices adapted for communication with a wired and/or wireless network. Communication component may be adapted to transmit and/or receive one or more wired and/or wireless video feeds.

In various embodiments, the network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) adapted to communicate with other communication networks, such as the Internet. As such, in various embodiments, the thermal scanning system 100 may be associated with a particular network link such as for example a URL (Uniform Resource Locator), an IP (Internet Protocol) address, and/or a mobile phone number.

Power component comprises a power supply or power source adapted to provide power to the low water monitoring system including each of the components. Power component may comprise various types of power storage devices, such as battery, or a power interface component that is adapted to receive external power and convert the received external power to a useable power for the low water monitoring system including each of the components.

Mode sensing component may be optional. Mode sensing component may include, in one embodiment, an application sensor adapted to automatically sense a mode of operation, depending on the sensed application (e.g., intended use for an embodiment), and provide related information to processing component. In various embodiments, the application sensor may include a mechanical triggering mechanism (e.g., a clamp, clip, hook, switch, push-button, etc.), an electronic triggering mechanism (e.g., an electronic switch, push-button, electrical signal, electrical connection, etc.), an electro-mechanical triggering mechanism, an electro-magnetic triggering mechanism, or some combination thereof. Alternately, for one or more embodiments, the mode of operation may be provided via control component by a user of the low water monitoring system.

Processing component may be adapted to communicate with mode sensing component (e.g., by receiving sensor information from mode sensing component) and regulation component (e.g., by receiving data and information from regulation component and providing and/or receiving command, control, and/or other information to and/or from other components of the low water monitoring system.

As used herein, the term “computer” may refer, but is not limited to a laptop or desktop computer, or a mobile device, such as a desktop, laptop, tablet, cellular phone, smart phone, personal media user (e.g., iPod), wearable computer, implantable computer, or the like. Such computing devices may operate using one or more operating systems, including, but not limited to, Windows, MacOS, Linux, UNIX, IOS, Android, Chrome OS, Windows Mobile, Windows CE, Windows Phone OS, Blackberry OS, and the like.

The system and process described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the disclosure may be implemented by performing or completing manually, automatically, or a combination thereof, selected steps or tasks.

The term “process” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40%or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be +10%of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7 -91.3) should also be understood to be intended as possible subrange endpoints unless specifically excluded.

It should be noted that where reference is made herein to a process comprising two or more defined steps, the defined steps can be carried out in any order or simultaneously (except where context excludes that possibility), and the process can also include one or more other steps which are carried out before any of the defined steps, between two of the defined steps, or after all of the defined steps (except where context excludes that possibility).

Still further, additional aspects of the invention may be found in one or more appendices attached hereto and/or filed herewith, the disclosures of which are incorporated herein by reference as if fully set out at this point.

Thus, the invention is well adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system for low water monitoring in agriculture, the system comprising:
a pressure regulation device removably connected to and in fluid communication with one or more water reservoir tanks, the pressure regulation device configured to supply air pressure to the reservoir tanks;
one or more water nipple assemblies removably connected to and respectively in fluid communication with the reservoir tanks; and
a computer processor in communication with the pressure regulation device, the computer processor comprising a controller configured to selectively adjust the air pressure supplied to the reservoir tanks in order to adjust water output volumes from the water nipple assemblies,
wherein the system for low flow water monitoring is an individual bird cage low flow water monitoring system.

2. The system of claim 1, wherein the pressure regulation device further comprises a reservoir pressure adjustment apparatus to selectively adjust the air pressure supplied from the pump to the reservoir tanks.

3. The system of claim 1, wherein the controller is further configured to selectively adjust a water volume within the reservoir tanks.

4. The system of claim 3, further comprising a pump to selectively adjust the water volume within the reservoir tanks in response real-time water level and consumption feedback.

5. The system of claim 1, wherein the reservoir tanks further comprise a water level sensor, an internal water volume sensor, a water level indicator device, or a load cell.

6. The system of claim 1, wherein the reservoir tanks deliver a water pressure of about 0.5 PSI to the one or more water nipple assemblies.

7. The system of claim 1, wherein the system for low flow water monitoring in the individual bird cage further comprises:
the pressure regulation device in fluid communication with a plurality of water reservoir tanks;
a plurality of water nipple assemblies respectively in fluid communication with the reservoir tanks, the water nipple assemblies in fluid communication with the individual bird cage; and
the computer processor further comprises:
a memory component in communication with or housed within the pressure regulation device;
a processing component in communication with or housed within the pressure regulation device, the processing component configured to selectively adjust the air pressure supplied to each of the reservoir tanks in order to adjust the water output volumes from the water nipple assemblies to the individual bird cage.

8. The system of claim 7, further comprising each of the reservoir tanks having a water volume or level sensor adapted to detect and provide water level readings within the reservoir tanks.

9. The system of claim 8, wherein the processing component is further configured to receive water level readings from the water volume or level sensors in the reservoir tanks, the processing component further configured to process the water level readings to generate water level and consumption data and information, and store the water level and consumption data and information in the memory component.

10. he system of claim 9, wherein the processing component is adapted to process the water level and consumption data and information to monitor water intake or one or more broiler chickens reared in the individual bird cage and store the water intake in the memory component.

11. The system of claim 10, further comprising a wireless communication component adapted to communicate with a user over a wireless network, wherein the water level and consumption data and information is collected locally via the processing component and provided to a computer over the wireless network via the communication component for remote viewing and analysis of the conditions by the user.

12. The system of claim 9, wherein the system for low flow water monitoring comprises a plurality of the pressure regulation devices having a plurality of corresponding reservoir tanks with water volume sensors to form a network of the water volume sensors, and wherein the water volume sensors are adapted to continuously monitor and provide feedback related to the water level and consumption data and information for the broiler chickens reared in the individual bird cage.

13. The system of claim 1, wherein no-leak quick connects fluidly and removably connect the water nipple assemblies to the reservoir tanks.

14. The system of claim 1, wherein the computer processor is configured to monitor water intake data and further configured to provide real-time water level and consumption feedback from the reservoir tanks.

15. A process for low flow water monitoring in agriculture using the system of claim 1.

16. The process of claim 15, comprising the step of installing the system for low flow water monitoring in the individual bird cage.

17. The process of claim 16, further comprising the steps of:
supplying water to an individual bird, animal or plant in the individual bird cage from the reservoir tanks filled with water;
selectively adjusting the air pressure supplied to the reservoir tanks using the pressure regulation device; and
measuring water consumption of the individual bird, animal or plant by weighing the water in the reservoir tanks.

18. The process of claim 17, further comprising the step of rearing broiler chickens in the individual bird cage.

19. The process of claim 17, further comprising the steps of providing real-time water level and consumption feedback using the computer processor in communication with the pressure regulation device.

20. The process of claim 17, wherein the step of supplying water to the individual bird further comprises the step of supplying water at a water pressure of about 0.5 PSI from the reservoir tanks to the one or more water nipple assemblies.
